(19) United States
(12) Patent Application Publication
(10) Pub. No.: US 2018/0033017 A1
(43) Pub. Date: Feb. 1, 2018

(54) COGNITIVE TECHNICAL ASSISTANCE CENTRE AGENT

(71) Applicant: Ramesh Gopalakrishnan IYER, Fremont, CA (US)

(72) Inventor: Ramesh Gopalakrishnan IYER, Fremont, CA (US)

(21) Appl. No.: 15/662,803

(22) Filed: Jul. 28, 2017

Related U.S. Application Data
(60) Provisional application No. 62/368,280, filed on Jul. 29, 2016.

(51) Int. Cl. G06Q 30/00; G06N 5/04; G06F 17/27; G06N 99/00

(52) U.S. Cl. CPC G06Q 30/016; G06N 99/005; G06N 5/043; G06F 17/2705; G06F 17/278; G06F 17/2785

(57) ABSTRACT

The present subject matter describes a method and a system for providing automated technical support for a product at a remote end from a Technical Assistance Center (TAC) at a technical support end. The TAC includes a cognitive TAC agent can act as substitute for technical personnel at the TAC. The cognitive TAC agent first learns about the product to which the technical support is to be provided and derives a cognitive dependency graph based on learning. Upon learning, the cognitive TAC agent can automatically provide the technical support for the product using the cognitive dependency graph, without manual intervention of the technical personnel.

### TECHNICAL FIELD

The present subject matter relates, in general, to providing product support and more particularly to a Technical Assistance Center (TAC) having a cognitive TAC agent as automated system for automatically providing technical support for the product.

### BACKGROUND

Companies that produce products, such as hardware and software products, often have technical personnel to provide technical support or product support to an end user using the product. The end user is interchangeably referred to as customer hereinafter. Usually, when there is a problem with respect to the product, the customer may use multiple channels such as a telephone call, an electronic mail (“e-mail”) message, etc. to receive the technical support from the technical personnel. The customer may raise a query regarding a problem to the technical personnel. In response, the technical personnel attempts diagnostics on the problem and provides specific instructions to resolve the problem on a step by step basis.

The increasing complexity and variety of technology products and services being offered to customers and rapid pace of change of these products and services is increasing the demand for expert customer service. This involves the timely and effective diagnosis and resolution of customer queries/problems that is vital to customer satisfaction and retention. For instance, users of a computer software product typically will have technical questions that can only be answered by the trained technical personnel who are familiar with the software. In a commercial environment of highly increased competition and reduced profit margins, it is challenging to reconcile the seemingly conflicting objectives of reducing customer support costs while improving support quality.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an example network environment in which embodiments of the present subject matter may be implemented.

FIG. 2 illustrates a block diagram of a Technical Assistance Center, in accordance with an example embodiment of the pressure subject matter.

FIG. 3 is a flow chart of an illustrative method of learning about a product, in accordance with an example embodiment of the pressure subject matter.

FIG. 4 is a flow chart of an illustrative method of collecting information related to the component and subcomponents of the product during the process of learning, in accordance with an example embodiment of the present subject matter.

FIG. 5a and FIG. 5b is a knowledge graph generated for an example product, in accordance with an example embodiment of the present subject matter.

FIG. 6 is a cognitive dependency graph generated for an example product, in accordance with an example embodiment of the present subject matter.

FIG. 7a and FIG. 7b is a flow chart of an illustrative method of providing a technical support for the product, in accordance with an example embodiment of the present subject matter.

FIG. 8 is a flow chart of an illustrative method of updating a knowledge database based on a feedback from the customer, in accordance with an example embodiment of the present subject matter.

### SUMMARY

This summary is provided to introduce a selection of concepts in a simplified form that are further described below in the detailed description. This summary is not intended to identify essential features of the claimed subject matter, nor is it intended to be used as an aid in determining the scope of the claimed subject matter.

In an embodiment of the present subject matter, a method of automatically providing a technical support for a product of the customer at a remote end is described. The method includes learning about the product having a plurality of components to construct a knowledge database having a look-up table of a set of questions and responses received from a technical expert to the set of questions. The questions may be related to the product for which the technical support is to be provided and the responses include specific instructions to solve one or more technical problems related to the product. Further, the method includes deriving a cognitive dependency graph based on the knowledge database. In an embodiment, the method further includes providing the technical support for the product of the customer at the remote end using the cognitive dependency graph.

In another embodiment of the present subject matter, a system for providing an automated technical support is described. The system comprises of a cognitive TAC agent having a learning module to learn about the product to construct a knowledge database, and a question and response parser module to generate questions related to the product and parse responses received from a technical expert to the questions. The knowledge database is used to derive a knowledge graph for the product that ties up all the components and sub components and the dependencies. The cognitive TAC agent further comprises a dependency graph generator, which generates a cognitive dependency graph based on the knowledge graph. In addition, the cognitive TAC agent includes a technical support module to provide the technical support for the product by using the cognitive dependency graph.

The present subject matter also describes a non-transitory computer readable medium, according to an embodiment of the present subject matter. The non-transitory computer-readable medium comprises computer-readable instructions, which, when executed by a processor in a system, cause the processor to learn about the product having a plurality of components to construct a knowledge database having a look-up table of a set of questions and responses received from a technical expert to the set of questions. The questions may be related to the product for which the technical support is to be provided and the responses include specific instructions to solve one or more technical problems related to the product. Further, a cognitive dependency graph may be derived based on the knowledge database. Further, the processor may provide the technical support for the product using the cognitive dependency graph.

### DETAILED DESCRIPTION

The present subject matter relates to an automated technical support system and a method for providing a technical support for a product of an end user or a customer at a remote end using a cognitive Technical Assistance Center (TAC) agent provided at a technical support end. The cognitive TAC agent can act as a substitute for technical personnel by automatically performing various functions without or with minimal user intervention.

Conventional techniques for providing technical support to an end user regarding any product is by employing technical personnel for providing the technical support on a global basis. The conventional techniques are based on chat or voice based interactive sessions where the end user requests for a support through the chat or voice sessions. In response, the technical personnel answer the queries and provides specific instructions to the end user either through the chat or voice in order to resolve the issue. The technical personnel may also refer the instruction manuals related to the product to provide the specific instructions to the end user to resolve the technical problem. In some conventional techniques, the service request from the end user is serviced at multiple levels till the root cause of the technical problem is identified and then provides specific instructions to solve the technical problem.

Further, in a technical support and service environment, a multitude of concurrent technical support calls may be active at any given time. With the increase in the number of concurrent calls and with the increase in the variety of technology products and services, there is an increased need in technical personnel to handle each technical problem. This requires a long and expensive cycle of hiring technical personnels, training them sufficiently on a particular product. Also, providing the technical support to the customers is 24/7 operation that require the companies to maintain the employees on round-the-clock-shift or have to maintain global offices in multiple countries.

Thus, the conventional techniques to provide technical support to the end user regarding the product are dependent on the highly trained technical personnels who responds to the queries of the end user and provides a step by step guidance till the technical problem is resolved.

The present subject matter relates to an automated technical support system and a method of providing a technical support for a product. The present subject matter is capable of providing the technical support for the product at a remote end from a Technical Assistance Center (TAC) at a technical support end, without or with minimal manual intervention of technical personnel or customer support representatives. This enables an organization to function with minimum technical personnel, thereby reducing costs associated with the technical support, while improving support quality.

In an embodiment of the present subject matter, a method of automatically providing a technical support for a product comprises learning about the product having a plurality of components to construct a knowledge database having a look-up table of a set of questions and responses received from a technical expert to the set of questions. The questions may be related to the product for which the technical support is to be provided and the responses include specific instructions to solve one or more technical problems related to the product. Further, the method includes deriving a cognitive dependency graph based on the knowledge database. The cognitive dependency graph may include a plurality of cognitive nodes having a root node and a tree of nodes and edges inter-connecting the nodes. Each node of the cognitive node may be encoded with a transitive sequence code, which represents a path from the root node to the corresponding cognitive node or traversal from a given node through a set of edges to another node in the graph. Each of the nodes, in addition may have attributes that categorizes them as particular type of nodes. Further, each cognitive node may be associated with a look up table having at least one of: one or more of the set of questions in the knowledge database, association of the questions to the encoded transitive sequence code, possible responses for each question, an edge to be traversed next based on the possible response, and a sequence of movement through nodes and edges till the technical problem associated with the service request is solved by this automated cognitive graph traversal.

In an embodiment, the method further includes providing the technical support for the product using the cognitive dependency graph. The method comprises sending one or more of the set of questions associated with a cognitive node in the look up table, through a communication interface, to a customer at the remote end in response to a service request from the remote end. The service request may include a statement of a technical problem with the product. Further, the method comprises obtaining a response at the technical support end, through the communication interface, for each question that is sent from the remote end. Next, the method includes automated processing of the response to provide the technical support.

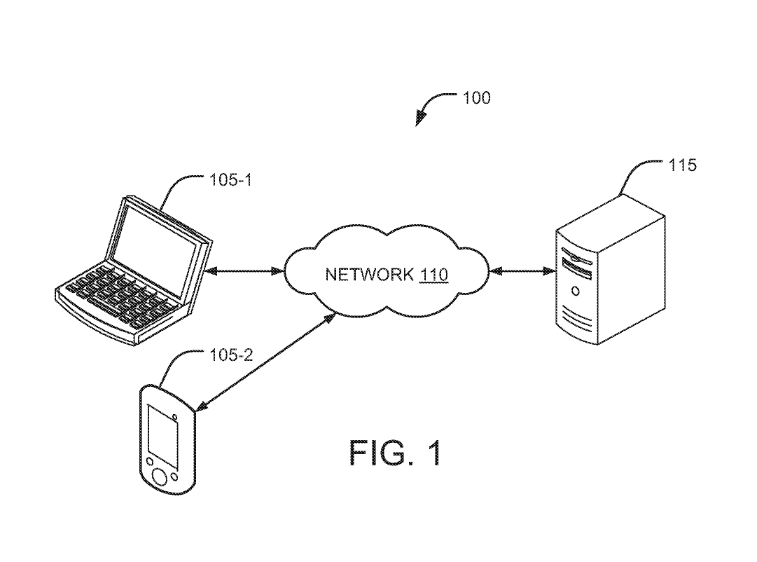

The present subject matter is further described in detail with reference to FIG. 1 to FIG. 8. It should be noted that the description merely illustrates the principles of the present subject matter. It will thus be appreciated that those skilled in the art will be able to devise various arrangements that, although not explicitly described herein, embody the principles of the present subject matter and are included within its spirit and scope. Furthermore, all examples recited herein are principally intended expressly to be only for explanatory purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

FIG. 1 illustrates an example network environment in which embodiment of the present subject matter may be implemented. The FIG. 1 is a client-server based environment 100, in which a customer uses one or more computing devices 105-1, 105-2 to connect via a network 110 to a Technical Assistance Center (TAC) 115 for receiving automated technical support for a product. The TAC 115 may provide at a technical support end from where the technical support is delivered to the customer at a remote end. The network 110 shown in the FIG. 1 may be the Internet, a LAN, a WAN, or a similar network.

Generally, product support, also called technical support, is a process by which a company or a manufacturer provides support or assistance to the customer for a product purchased from the company.

In an embodiment, the TAC 115 may be configured as one or more software applications or code sets that are operating on a single computing device such as a server or distributed over multiple computing devices. In another embodiment, the TAC 115 can be arranged using hardware and/or firmware, or various combination of the hardware, firmware, or software as may be needed to meet the requirements of providing the automated technical support.

In an embodiment, the product that needs service may include a plurality of functional components having at least one of: one or more software components and one or more hardware components. Examples of the product include, but are not limited to, an application software, a computer deployed device, and a computer implemented support service. The present subject matter can be implemented to provide the technical support to any product or service. For the sake of brevity, hereinafter, the explanation is provided with respect to the product.

However, it will be understood to a person skilled in the art that the technical support can also be provided for any service by implementing the present subject matter.

As shown in the FIG. 1, the computing devices 105-1, 105-2 of the customer are coupled to the network 110 for sending and receiving information from the TAC 115. For example, the end user computing devices 105-1, 105-2 may include mobile phones, e-mail appliances, smart phones, Personal Digital Assistants (PDAs), personal computers, tablet devices, and the like. For the sake of brevity, the end user computing devices 105-1, 105-2 have been commonly referred to as a computing device 105, hereinafter.

The customer may interact with the TAC 115 over multiple contact channels such as telephone, email, chat, etc. using the computing device 105. The TAC 115 provides an automated technical support for any product. The TAC 115 may include a Natural Language Processing (NLP) engine (not shown in the FIG. 1) to interact with the customer at the remote end, for example, to understand the service request from the customer and to send instructions that can be understandable by the customer. The service request may include a statement of a technical problem with the product. For example, the NLP engine is one of LUIS.ai or API.ai, which are known to a person skilled in the art. Further, the TAC 115 includes a cognitive TAC agent (not shown in the FIG. 1) to provide an automated technical support to the customer. The cognitive TAC agent can act as substitute for technical personnel by automatically performing various functions without (or with minimal) user intervention. The cognitive TAC agent can receive service requests from a customer and provides enough information to allow the customer to solve the technical problem with the product.

As known to a person skilled in the art, the NLP engine works on “Intents” and “Entities” to make decisions. Intents are the intentions of the end-user; these intentions or intents are conveyed by the technical assistance center or the end user with respect to the product. Entities are components upon which action is performed and may have properties such as state (on/off), etc. Intents and Entities are identified using “Part-of-Sentence” (POS) tagging”, which is known to a person skilled in the art. For instance, when the customer sends a request, “DOCUMENT IS NOT PRINTING”, the NLP engine identifies intents and entities in the customer request. In this example, NLP engine identifies PRINTING as an intent and DOCUMENT as entity. Based on the identified intents and entities in the technical query from the customer, the TAC processes the customer request working through a cognitive dependency graph of that product to provide technical support by diagnosing the problem and provide specific instructions to the customer for resolving the problem.

The configuration in environment 100 shown in the FIG. 1 is an example and provided for simplicity. In practice, according to other embodiment's, environment 100 may include additional devices, fewer devices, different devices, and/or differently arranged devices, then those illustrated in FIG. 1. For instance, the environment may include additional computing devices of other customers through with the other customers can also send a service request regarding the product to the TAC 115.

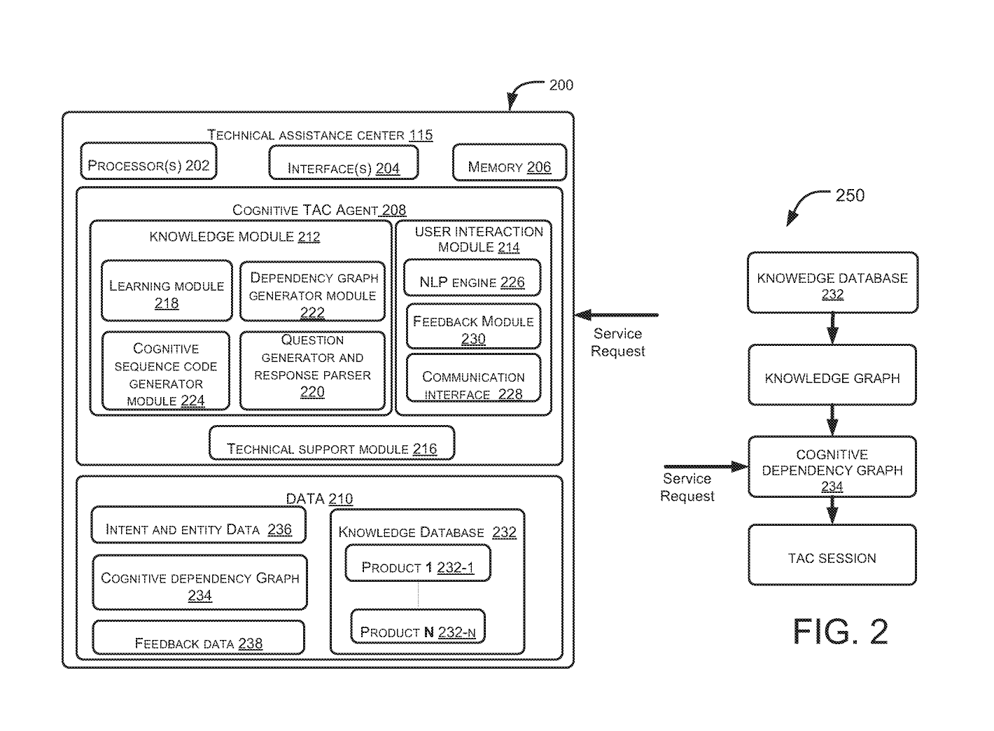

FIG. 2 illustrates a block diagram of a Technical Assistance Center (TAC) provided at a technical support end, in accordance with an example embodiment of the pressure subject matter. As discussed with respect to the FIG. 1, the environment 100 may be client-server based environment.

In an embodiment, the TAC 115 may include different components such as processor(s) 202, interface(s) 204, and a memory 206. Further, the TAC 115 may include module (s) such as a cognitive TAC agent 208, and data 210.

The processor 202, amongst other capabilities, may be configured to fetch and execute computer-readable instructions stored in the memory 206. The processor 202 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processor(s)” 202, may be provided through the use of dedicated hardware as well as hardware capable of executing software in association with appropriate software. When provided by a processor 202, the functions may be provided by a single dedicated processor, by a single shared processor, or by a plurality of individual processors, some of which may be shared.

The interface(s) 204 may include a variety of machine readable instructions-based interfaces and hardware interfaces that allow the TAC 115 to interact with different entities, such as the processor 202, the cognitive TAC agent 208, and the data 210. Further, the interfaces 204 may facilitate multiple communications within a wide variety of networks and protocol types, including wireless networks, wireless Local Area Network (WLAN), RAN, satellite-based network, etc.

The memory 206 may be coupled to the processor and may, among other capabilities, provide data and instructions for generating different requests. The memory 206 can include any computer-readable medium known in the art including, for example, volatile memory, such as static random access memory (SRAM) and dynamic random access memory (DRAM), and/or non-volatile memory, such as read only memory (ROM), erasable programmable ROM, flash memory, hard disks, optical disks, and magnetic tapes.

The module(s) may include routines, programs, objects, components, data structures, and the like, which perform particular tasks or implement particular abstract data types. Further, the module can be implemented in hardware, instructions executed by a processing unit, or by a combination thereof.

The modules include the cognitive TAC agent 208, which includes a knowledge module 212, a user interaction module 214, and a technical support module 216. The knowledge module 212 further includes a learning module 218, a question generator and response parser (QGRP) module 220, a cognitive dependency graph generator (CDGG) module 222, and a cognitive sequence code generator (CSCG) module 224. The user interaction module 214 further includes a NLP engine 226, a communication interface 228, and a feedback module 230.

In another aspect of the present subject matter, the module(s) may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The data serves, amongst other things, as a repository for storing data that may be fetched, processed, received, or generated by one or more of the module(s). As shown in the TAC 115, the data may include, but not limited to, a knowledge database 232 constructed for one or more products, a cognitive dependency graph 234, intent and entity data 236, feedback data 238, and data associated with different nodes of the cognitive dependency graph.

In operation, the cognitive TAC agent 208, as described herein, can operate as a substitute for technical personnel by automatically performing various functions without or with minimal intervention of the technical personnel. The cognitive TAC agent 208 can receive service requests from a customer and provides enough information to allow the customer to solve the technical problem with the product. The cognitive TAC agent 208 may first learn about the product to which the technical support is to be provided and then automatically provides the technical support for that product, without manual intervention of the technical personnel.

The learning module 218 of the cognitive TAC agent may learn about the product for which the technical support is to be provided. The learning module 218 of the TAC 115 may use the QGRP module 220 to learn about the product. In an aspect, the QGRP module 220 may generate questions related to the product and the learning module 218 may interact with a technical expert and pose the questions. For example, the technical expert is one of an engineer who developed the product or any other person having knowledge about the product.

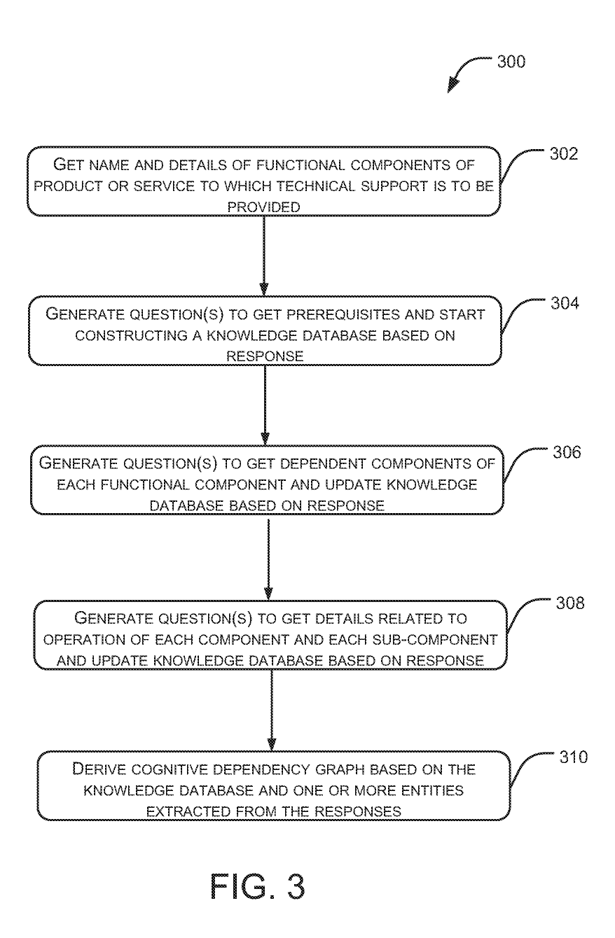

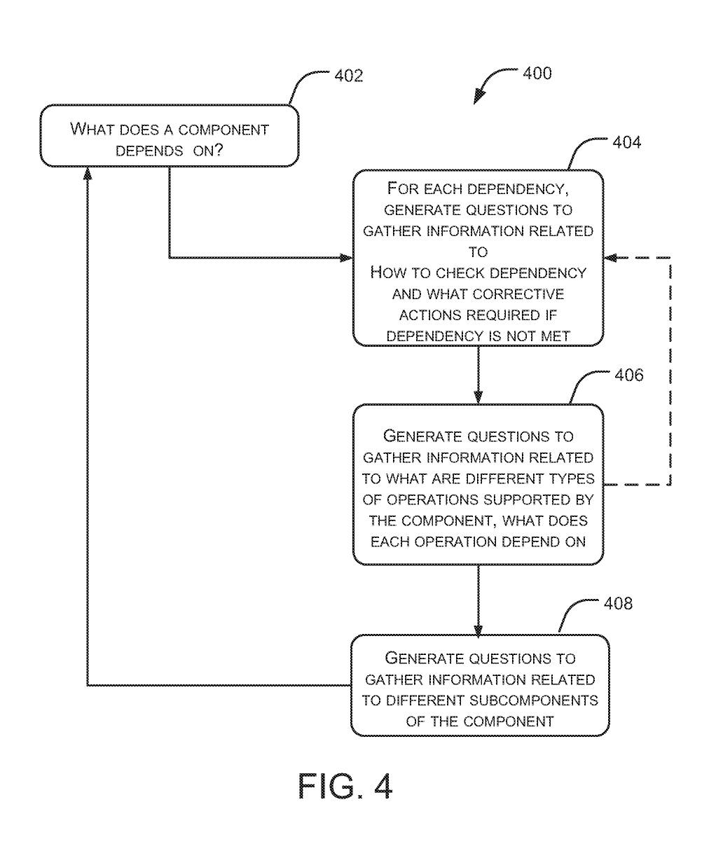

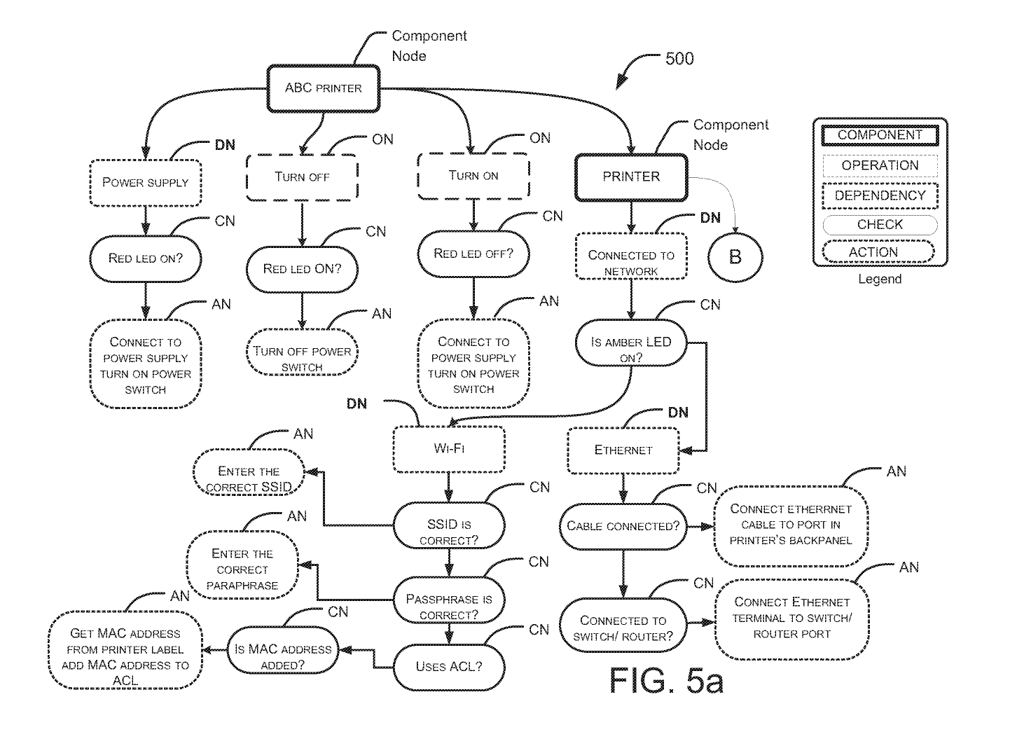

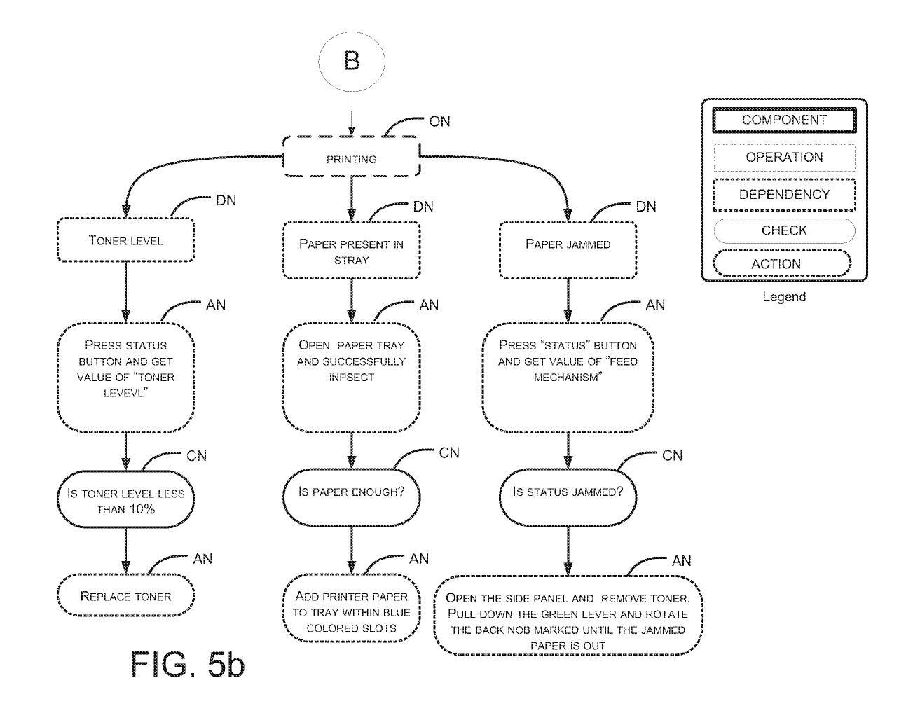

The learning module 218 may interact, through the communication interface 228, with the technical expert by using the NLP engine 226. As previously discussed, the NLP engine 226 relies on intents and entities. The NLP engine, for example, LUIS.ai, may use its in-built intents and entities, based on which the QGRP module 220 generates questions about the product. In an aspect, the generated questions may be referred as smart questions because each question that is generated by the QGRP module 220 may be based on a response from the technical expert for a previous question. For example, a second question generated by the QGRP module 220 depends on a response to a first question from the technical expert. For instance, a first question may be ‘what is the name of the product’. When the response to the first question is a printer, then the second question generated by the QGRP module 220 may be ‘what are different components of the printer’. The learning module 218 poses the generated second question to the technical expert, and in response to the second question, a third question related to the product may be generated by the QGRP module 220. This process continues till the learning module 218 has complete information about the product. The process of learning is explained in detail with respect to FIG. 3, FIG. 4, FIG. 5a, and FIG. 5b.

During the process of learning about the product, the NLP engine 226 may extract intents and entities from each response received from the technical expert. Based on the extracted intents and entities, the cognitive TAC agent 208 may construct an intent and entity database storing intent and entity data 236.

Further, the knowledge module 212 may construct a knowledge database 232 having a look-up table of a set of questions and responses received from the technical expert to the set of questions for each of the products 1 to N that may be serviced by the TAC agent. The questions may be related to the product for which the technical support is to be provided and the responses include specific instructions to identify a root cause of the technical problem and to provide a solution to the identified root cause. In an example, the knowledge database 232 may be stored in the memory of the server computer. In another example, the knowledge database 232 may be stored in a cloud from where the TAC 115 can access the information from the database for providing the automated technical support to the customer. The knowledge data in the knowledge database 232 may be represented in the form of a graph.

The TAC flow is illustrated in 250 of FIG. 2. The knowledge base 232 is used to construct a knowledge graph from which a cognitive dependency graph is configured and this is used during the TAC session starting from a service request. The components as illustrated in 200 provide the systemic components to enable the functionality shown in 250.

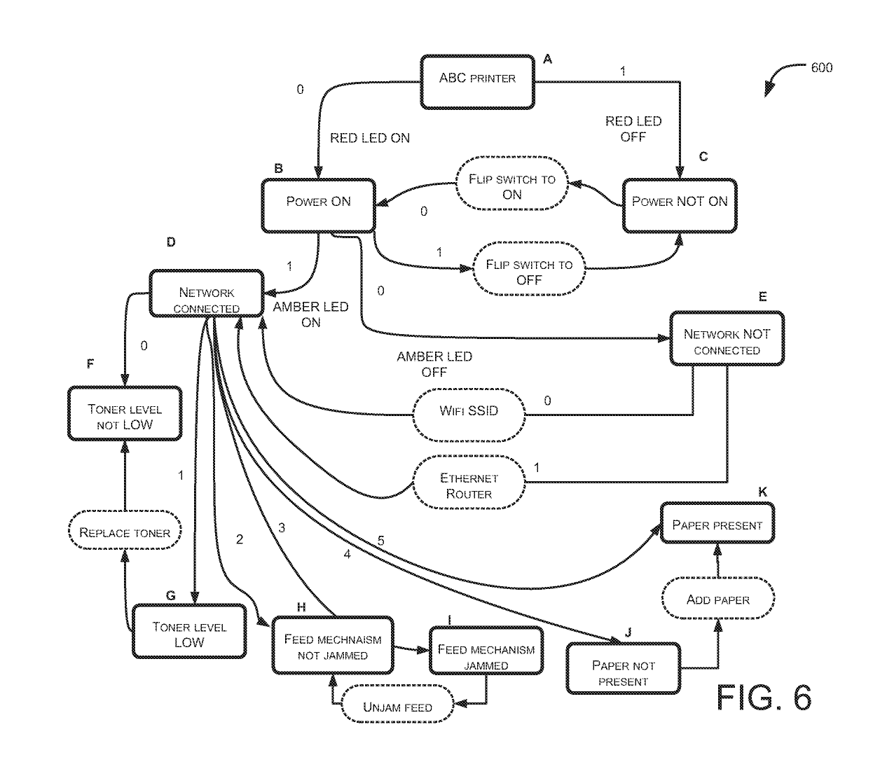

Based on the knowledge graph configured from the knowledge database 232 for the product and one or more entities extracted during the learning process, the CDGG module 222 may derive a cognitive dependency graph 234 for the product. The process of deriving the knowledge graph is explained in detail with respect to FIG. 5a and FIG. 5b and using this the construction of the cognitive dependency graph using the knowledge graph is explained in detail with respect to FIG. 6.

In an aspect, the cognitive dependency graph 234 may be used to provide the technical support for the product of the customer at the remote end based on a technical problem statement received from the remote end. The cognitive dependency graph 234 may be uniquely associated with the product for which the technical support is to be provided by the cognitive TAC agent 208.

The cognitive dependency graph 234 may include a plurality of cognitive nodes having a root node and edges connecting the nodes in the cognitive dependency graph 234. The CDGG module 222 may use the CSCG module 224, which may generate a transitive sequence code for each cognitive node and the generated transitive sequence code may be encoded with each cognitive node. In an aspect, the transitive sequence code represents a path from the root node to the corresponding cognitive node. For each cognitive node, the CDGG module 222 may associate a look up table having at least one of: one or more of the set of questions in the knowledge database, possible responses for each question and one or more of the specific instructions for resolving a technical problem with the product. The one or more of the set of questions associated with the corresponding cognitive node depends on the transitive sequence code encoded with the corresponding cognitive node.

Further, the cognitive TAC agent 208 may include a technical support module 215 to provide the technical support for the product of the customer at the remote end. The technical support module 216 may understand the service request including the technical problem statement related to the product, from the customer, by using the NLP engine 226. The technical statement may be specific to the language that the NLP is built for as known in art. Upon processing the technical problem statement through the NLP, the technical support module 216 may determine a root cause of the technical problem by overlaying the entity and intent identified by the NLP at each stage on the cognitive dependency graph 234 derived for that product. The NLP processing intents and entities help converge to a specific node of the cognitive dependency graph at the beginning of a technical service request and at further stages in the technical assistance trail generate information for the intent and entities to take a specific edge of the cognitive dependency graph to the next node from a given node at which a question is posed and answer NLP processed. For example, if the customer sends a service request for XYZ printer, then the technical support module 216 identifies the cognitive dependency graph for the XYZ printer and determines the root cause of the technical problem using the corresponding cognitive dependency graph from a series of questions and answers that are routed through the NLP processing.

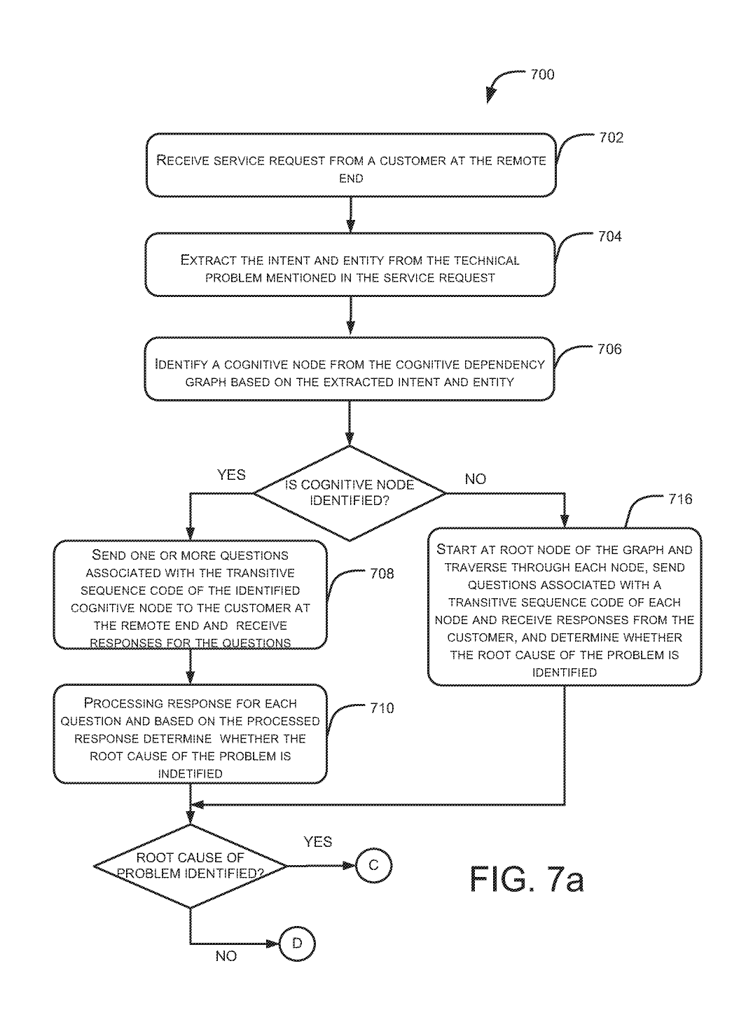

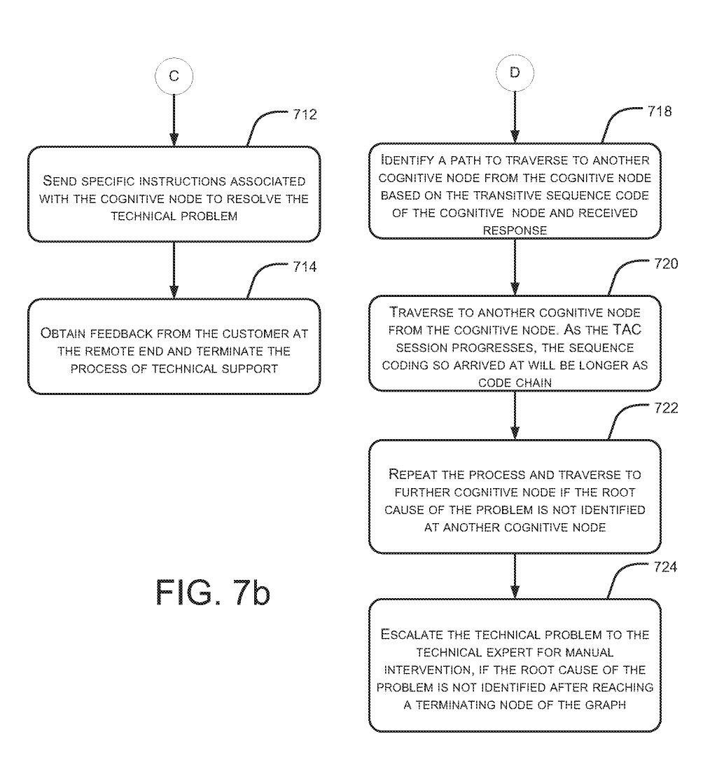

In an embodiment, the cognitive TAC agent 208 may escalate the technical problem to the technical expert for manual intervention if the root cause of the problem is not identified by using the cognitive dependency graph 234 derived for that product. The process of providing the technical support using the cognitive dependency graph 234 is explained in detail with respect to FIG. 6, FIG. 7a, and FIG. 7b.

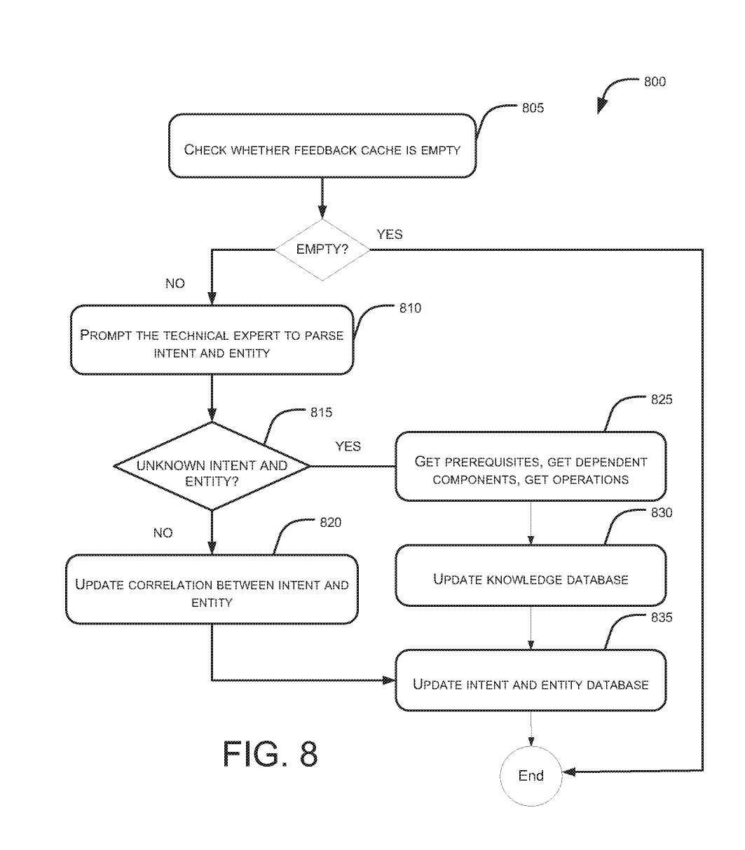

Further, the feedback module 230 may obtain the feedback from the customers for each service request and updates feedback data 238. The feedback may include whether the technical problem is successfully resolved or not. The feedback module 230 may provide the feedback data 238 to the knowledge module 212, and the knowledge module 212 may update the knowledge database 232 using the QGRP module 230 if the technical problem is not resolved successfully. The process of obtaining feedback and using the feedback data for updating the knowledge database 232 is explained in detail with respect to the FIG. 8 of the present disclosure. The feedback data may be used to modify the knowledge database 232 by adding data and also modify the cognitive dependency graph which till that feedback receipt has not historically seen that problem that was not part of the cognitive dependency graph.

Provisioning of the cognitive TAC is further described with respect to various method flow charts. The order in which the method blocks are described is not included to be construed as a limitation, and some of the described method blocks can be combined in any order to implement the described method, or an alternative method. Additionally, some of the individual blocks may be deleted from the described method without departing from the scope of the subject matter described herein. Furthermore, some of the blocks of the described method can be implemented in any suitable hardware, software, firmware, or combination thereof.

FIG. 3 is a flow chart of an illustrative method of learning about any product, in accordance with an example embodiment of the pressure subject matter. For the sake of understanding, the explanation is provided herein with the help of a product named ‘ABC printer’. However, it is understood to a person skilled in the art that the present subject matter is not limited to a particular product.

As previously discussed, the learning module 218 of the cognitive TAC agent 208 may first learn about the product for which the technical support is to be provided. The product may include plurality of functional components including at least one of: one or more hardware components and one or more software components. For example, the ‘ABC printer’ is a special type of multifunction printer, which may include hardware components such as printer, copier and scanner, and operational software components such as a device driver. The learning module 218 may interact with the technical expert for posing questions, related to the ‘ABC printer’ and its operation software components.

For generating questions, the QGRP module 220 may use in-built intents and entities. At 302, the QGRP module 220 may generate a question to obtain a name and details of the functional components associated with the product. For the above printer example, the QGRP module 220 generates a question to obtain information related to the name of the printer and whether the printer includes hardware components or software components or both the type of components. After obtaining the response to the question from the technical expert, the QGRP module 220 may parse the response to identify intents and entities with the help of the NLP engine 226 and generates a next question based on the identified intent and entity. Techniques for identifying intents and entities, from a statement, with the help of the NLP engine is known to a person skilled in the art. The process is continued till the operation hardware and software components can be associated with a plurality of intents and entities that can be used to construct the cognitive dependency graph and on mapped to the intents and entities that are identified by the NLP engine to traverse through the nodes of the cognitive dependency graph during a TAC session. During the learning process, the cognitive TAC agent 208 may construct the knowledge database 232 having one or more look-up tables storing each question and corresponding response and the questions and answers are related one to one with the entities and intents in the intent and entity database.

In an embodiment, if the product includes both the hardware and software components, then the learning module 218 may first learn about the hardware components, and then the software components. In another embodiment, the learning module 218 first learns about the software components, and then the hardware components.

Next, at step 304, the QGRP module 220 may generate a question to obtain information related to different prerequisites of the product. For the above printer example, the different prerequisites may include a power supply condition based on which the printer starts working. After receiving each response from the technical expert, the learning module 218 may update the knowledge database 232. Further, in the above example, the QGRP module 220, with the help of NLP engine 226, may extract ‘power ON’, ‘power OFF’ as entities from the response and stores the extract entity in the intent and entity database. For the above printer example the root PRINTER may be an entity and branch out to one of two entities ‘power ON’/‘power OFF’ through intents ‘red lamp glowing’/‘red lamp not glowing’. These two entities may be associated with specific nodes of the cognitive dependency graph.

Next at 306 and 308, the QGRP module 220 may generate questions by recursively focusing on each component and each sub-component of the product along with its associated operations. For instance, the questions may include, but are not limited to, what are the different components, what are different sub components of each component, what does the component and the subcomponent depends on, what are dependencies of each prerequisite, and how to check whether each dependency is met. Further, the questions include what are the possible operation supported by each component and each sub component, what does each operation depends on, how to check whether each operation is successful, how to rectify if the operation is not successful, what are commands to start the components and its sub components, and what are commands to stop the components and its sub components.

For instance, for the above printer example, the QGRP module 220 may generate a question ‘what does the printer depend on’ to the technical expert. The technical expert may respond to the question by stating that ‘Printer must be connected to a network’. Based on this response, the QGRP module 220 generates a further question, ‘How to check for Printer must be connected to a network’ to the technical expert. The technical expert may respond to the question by stating that ‘Amber LED on the front panel must be ON’. Based on this response, the QGRP module 220 generates a next question, ‘How to correct issues related to “<ABC>Printer must be connected to a network’. Likewise, the QGRP module 220 may generate questions for each component and each sub-component of the product along with its associated operations. After receiving response for each question, the cognitive TAC agent 208 may update the knowledge database 232 for that product and the intent and entity database. The flow of generating different questions by the QGRP module 220 is explained in detail with respect to FIG. 4.

At step 310, the CDGG module 222 may generate a cognitive dependency graph for the product using the knowledge database 232 and one or more extracted entities stored in the intent and entity database. In an aspect, the knowledge data in the knowledge database 232 may be stored in the form of a knowledge graph, as shown in the FIG. 5a and FIG. 5b. Based on the knowledge graph 500 for the product, the CDGG module 222 may derive the cognitive dependency graph 234. The process of deriving the cognitive dependency graph from the knowledge graph is explained in detail with respect to FIG. 6. A series of learning sessions may build the intent and entity database for a given product and that enables the construction of a cognitive dependency graph. The cognitive dependency graph is used for traversing during the TAC session with the intents and entities generated from answers to specific questions posed by the TAC engine to the service request and mapping these to the cached intents and entities during the learning sessions and traverse the nodes of the cognitive dependency graph in the TAC session.

In an aspect, the cognitive dependency graph 234 that is derived may include a plurality of cognitive nodes having a root node and edges connecting the nodes in the cognitive dependency graph 234. The CSCG module 224 may generate a transitive sequence code for each cognitive node and the generated transitive sequence code is encoded with each cognitive node. In an aspect, the transitive sequence code may represent a path from the root node to the corresponding cognitive node. For each cognitive node, the CDGG module 222 associates a look up table having at least one of: one or more of the set of questions in the constructed knowledge database, possible responses for each question and one or more of the specific instructions for resolving a technical problem. The one or more of the set of questions associated with the corresponding cognitive node depends on the transitive sequence code encoded with the corresponding cognitive node.

In an aspect, the technical support module 216 may use the cognitive dependency graph 234 to provide the technical support for the product of the customer at the remote end. The process of providing the technical support for the product of the customer at the remote end from the TAC 115 at the technical support end, is explained in detail with respect to FIG. 7a and FIG. 7b.

FIG. 4 is a flow chart of an illustrative method of collecting information related to the product during learning, in accordance with an example embodiment of the present subject matter. In particular, the FIG. 4 explains the flow of obtaining information related to the product during the process of learning.

At 402, the QGRP module 220 may generate a question, such as ‘what does a component depend on’, and the learning module 218 obtains response to the question from the technical expert. At 404, for each dependency, the QGRP module 220 may generate questions such as how to check each dependency and what corrective actions required if the dependency is not met. Next, at step 406, the QGRP module 220 may generate question such as what are different types of operation supported by the component and what does each operation depends on. For each operation dependency, the step 404 is repeated. Further, at 408, the QGRP module 220 may further generate questions such as what are different sub-components of the component, and for each sub-component, the steps 402, 406, and 408 are repeated. Similarly, for all the components, for example, printer, scanner, copier, and fax, and for each-sub component, the above steps are repeated to collect information related to the product. For each response, the knowledge database 232 and the intent and entity database are updated by the cognitive TAC agent 208.

FIG. 5a and FIG. 5b is a knowledge graph generated from the knowledge base after a learning session for an example product, in accordance with an example embodiment of the present subject matter. As previously discussed, during the learning process, the knowledge database 232 may be constructed. The constructed knowledge database 232 for an example product ‘ABC printer’ is represented in the form of a knowledge graph 500, as shown in the FIG. 5a and FIG. 5b. The graph 500 shown in the FIG. 5a and the FIG. 5b include different type of nodes such as a component node, an operation node (ON), a dependency node (DN), a check node (CN) and an action node (AN). As will be appreciated by one skilled in the relevant art, different types of nodes are indicated in the graph 500 are for illustration purpose only and is not intended to be limiting any way.

As shown in the graph 500, the component named ‘ABC printer’ has a dependency node (DN) ‘power supply’. As previously discussed, the QGRP module 220 may generate a question to know the dependencies of each component and each sub component, and the generated questions may be send to the technical expert. In response, the technical expert may provide the response to the learning module 218. For the above printer example, one of the dependency of the ‘ABC printer’ is a power supply. Upon receiving the dependency information of the ‘ABC printer’, the QGRP module 220 may further generate a question to how to check for power supply'. As shown in the graph 500, one of the way to check the power supply is to check whether the Red LED is ON, and this checking option is stored in a check node (CN). After receiving the information related to how to check the dependency, the QGRP module 220 may generate a question, ‘how to correct the dependency if the Red LED is not ON’. In response, the technical expert may provide instructions or actions to be performed to correct the dependency, and the received instructions or an action plan is stored in an action node (AN). For this example, the action to be taken to correct the dependency may be ‘connect to the power supply and turn ON the power switch’.

Next, the QGRP module 220 may generate a question, ‘what operations are supported by the printer’. The technical expert may respond to the question by stating that ‘Turn OFF’ and ‘Turn ON’ operations are supported by the printer, and these two operations are stored in operation nodes (ON), as shown in the FIG. 5a. Further, for each operation, the QGRP module 220 may generate questions to check dependencies and how to check and correct the dependencies. For this printer example, the ‘Turn ON’ operation depends on the Red LED and it must be ON, and if the Red LED is not ON, the corrective action to be taken is stored in an action node (AN). The action to be taken if the Red LED is not ON is ‘connect to the power supply and turn ON the power switch’. These operations, their dependencies, and corrective actions are stored in different nodes, as shown in the FIG. 5a.

Further, the QGRP module 220 may generate a question to know what are different subcomponent of the ABC printer. The technical expert may respond by stating that different subcomponents are printer, copier, scanner, and fax. For each component, the QGRP module 220 may generate questions to know the dependencies, sub-components, operations etc. In the FIG. 5a and the FIG. 5b, the explanation is provided with respect to one of the component ‘printer’, and the same applies to other components such as copier, scanner, and fax of the ‘ABC printer’.

As can be seen from the FIG. 5a, one of the dependency of the component ‘printer’ is whether the printer is connected to network, and this information is stored in a dependency node (DN). Further, the check of this dependency, i.e., how to check whether the printer is connected to a network is by checking whether Amber LED is ON, and this information is stored in a check node (CN). Next, the QGRP module 220 may generate a question to know what are the steps to be followed if the Amber LED is not ON. The technical expert may provide different steps for different ways of connecting to the network. One of the way to connect to network is through Wi-Fi and other way to connect to the network is through Ethernet. For each method, different types of checks and different corrective actions may be required, and this information is obtained from the technical expert and stored in the graph at different nodes. As shown in the FIG. 5a, for the Wi-Fi connection, different checks include, whether SSID is correct, whether passphrase is correct, is MAC address etc. For each check, information related to correction action to be performed is obtained and stored in the graph.

Similarly, as shown in the FIG. 5b, the QGRP module 220 may generate a question, ‘what are the operations supported by the printer’. In response, the technical expert may respond by stating the operation supported is printing, and this information is stored in an operation node. For this printing operation, the steps of identifying dependencies, checking dependencies, corrective actions to be taken for each dependency are repeated. For example, the printing operation depends on three different dependencies, such as, toner level, paper present in stray, and paper delivery mechanism not be jammed, as shown in the FIG. 5b. Likewise, the QGRP module 220 may generate questions for other components such as the copier, the scanner, and the fax of the ‘ABC printer’, and the obtained response is stored in the graph at different nodes.

The knowledge graph 500 may be used to derive the cognitive dependency graph for the product ‘ABC printer’, and the derived graph may be used to provide technical support for the ‘ABC Printer’ of the customer at the remote end.

FIG. 6 is a cognitive dependency graph generated for an example product, in accordance with an example embodiment of the present subject matter. The cognitive dependency graph 234 shown in the FIG. 6 may be derived from the knowledge graph 500 for the ‘ABC printer’, which is shown in the FIG. 5a and the FIG. 5b. As will be appreciated by a person skilled in the art, the cognitive dependency graph 234 shown in the FIG. 6 is for understanding purpose only and is not intended to be limiting the scope of the present subject matter any way.

To derive the cognitive dependency graph 234 from the knowledge graph 500, the CDGG module 222 may perform a depth first search on the knowledge graph 500, starting from a root node. In an aspect, the root node of the knowledge graph 500 may be retained as a root node for the cognitive dependency graph 234. When a dependency node (DN) arrives during the traversal, a check node (CN) after the dependency node (DN) may result in two edges in the cognitive dependency graph 234. One edge is for check pass and other edge is for check fail. The check fail edge may arrive at one cognitive node in the dependency graph 234 and the check pass edge may reach to another cognitive node in the dependency graph 234. Further, after traversing to another cognitive node through the check fail edge, there may be an action node between the cognitive node and another cognitive node.

For instance, in FIG. 5a, if the ‘ABC printer’ has a dependency node (DN) ‘Power supply’, ‘Red LED ON’ (CN) and ‘CONNECT TO POWER SUPPLY TURN ON POWER SWITCH’ an action node AN it will map to the part of the dependency graph having root node ‘ABC Printer’, with two edges “Red LED ON” and “Red LED OFF” as part of the DN Red LED leading to the fork out to the component status nodes (CN) of ‘POWER ON’ and ‘POWER NOT ON’. The action node ‘CONNECT TO POWER SUPPLY TURN ON POWER SWITCH’ gets mapped to edges ‘Flip switch to ON’ connecting directionally from the node ‘Power NOT ON’ to ‘Power ON’. Likewise, the construction of the cognitive dependency graph 234 is progressed for all the dependency nodes (DN), component codes and action nodes (AN) in the knowledge graph 500. An exemplified part of the cognitive dependency graph 234 that is derived is shown in the FIG. 6, and the graph 234 is having cognitive nodes named such as A to J. In addition, each node and edge of the graph 234 is mapped to at least one of an entity and an intent that are extracted from the responses obtained from the technical expert from the knowledge base through the configuration of the knowledge graph. In an embodiment, this mapping may be included in the look-up table associated with each cognitive node.

In another example in the illustrative FIG. 6, a node for the ‘ABC PRINTER, could be ‘NETWORK CONNECTED” named D. It is to be noted that each node is individually and uniquely labelled in this cognitive dependency graph 234. The ‘Power ON’ node is connected through a ‘Amber LED ON’ dependency to the ‘NETWORK CONNECTED’ node. A second forking edge from the ‘Power ON’ node could connect to the ‘NETWORK NOT CONNECTED’ node through the ‘Amber LED OFF’ dependency.

The cognitive dependency graph 234 has a predominant forward flow starting from a root node and passing through the decision-making edges formed by the DNs and ANs to other nodes. Each DN and AN is encoded and so the path traced from the root node through the DNs and ANs is encoded in the traverse path from the root node. For example, if the Amber LED edge is encoded by ‘X’ and ‘!X’. The ‘X’ is the code for the Amber LED in the knowledge graph, and X coding means affirmative for the Amber LED glowing and ‘!X’ means not glowing. In such a case, transitive sequence code ‘BXD’ which is encoded with cognitive node D would mean that the Printer is power ON and connected to network. Alternatively, a transitive sequence code ‘!XE’, which is encoded with the cognitive node E would mean that the printer is powered ON but not connected to the network during the TAC session.

As the TAC session progresses, the sequence coding so arrived at will be longer and longer as code chain that traces the TAC session questions and the answers picked up through the NLP engine. Each such sequence code at a given node is linked to a set of questions from the knowledge base and the knowledge graph so that this sequence can be advanced till the service problem is solved.

As appreciated by the person skilled in the art, the graph 234 shown in the FIG. 6 is only for illustration purpose and is not intended to be limiting any way. Based on the derived cognitive dependency graph 234, the cognitive TAC agent 208 may provide the technical support for the product of the customer at the remote end, without manual intervention or with minimal intervention of the technical personnel.

FIG. 7a and FIG. 7b is a flow chart of an illustrative method of providing a technical support to an end user regarding the product, in accordance with an example embodiment of the present subject matter.

At 702, a service request may be received at the TAC 115 from the customer at the end. The customer may use one of contact channels such as telephone, email, chat, etc. to send the service request to the TAC 115. The service request includes a statement of a technical problem with the product.

At 704, the NLP engine 226 of the TAC 115 may extract at least one of an intent and entity from the received technical problem statement. For instance, if the technical problem statement is, “My printer is not working”, then then NLP engine 226 first parses the technical problem statement and extracts intent and entity. In this example, the intent is ‘working’ and the entity is ‘printer’.

In an embodiment, at 706, a cognitive node is identified from the plurality of nodes in the cognitive dependency graph 234. For example, the cognitive node is identified from the plurality of nodes in the graph 234 by matching at least one of the extracted intent and entity with intents and entities associated with the cognitive nodes, starting from the root node of the graph 234. For instance, if the entity extracted from the service request is ‘printout’, then the technical support module 216 of the cognitive TAC agent 208 identifies that the relevant entity for the extracted entity is ‘printer’, and accordingly selects a cognitive node for which the entity ‘printer’ is mapped.

Next at 708, if the cognitive node is identified from the plurality of cognitive nodes of the cognitive dependency graph 234, then the method includes sending one or more questions, associated with a transitive sequence code of the cognitive node, to the customer at the remote end. Further, at 710, based on the response received for the sent questions, the technical support module 216 may process the response to determine whether the root cause of the problem is identified or not. In an embodiment, the technical support module 216 may map the received response with possible responses stored in look-up table for the corresponding question.

Further, a determination is made to identify whether the root cause of the technical problem is identified based on the mapping received response with the possible response. If it is determined that the root cause of the technical problem is identified, then the technical support module 216 may send specific instructions associated with the transitive sequence code, which is encoded with the corresponding cognitive node to resolve the technical problem, as stated at 712. Upon providing the specific instructions to the customer, the technical support module 216 may seek further inputs or feedback from the customer to find out whether the technical problem is successfully resolved or not, as stated at 714. Once the technical problem is successfully resolved based on the specific instructions, the technical support module 216 may terminate the process of technical support.

If the technical problem is not successfully resolved after providing the specific instructions, then the technical support module 216 may escalate the technical problem to higher level, for example, to the technical expert for manual intervention.

Referring to step 710, if it is determined that the root cause of the problem is not identified based on the received response from the customer, then the technical support module 216 may identify a path or edge of the cognitive dependency graph 234 to traverse to another cognitive node of the cognitive dependency graph 234 from the cognitive node based on the transitive sequence code associated with the cognitive node and based on the received response, as stated at 718.

For example, if the Amber LED edge is encoded by ‘X’ and ‘!X’. The ‘X’ is the code for the Amber LED in the knowledge graph, and X coding means affirmative for the Amber LED glowing and ‘!X’ means not glowing. In such a case, transitive sequence code ‘BXD’ which is encoded with cognitive node D would mean that the Printer is power ON and connected to network. Alternatively, a transitive sequence code ‘!XE’, which is encoded with the cognitive node E would mean that the printer is powered ON but not connected to the network during the TAC session. To traverse to the next node (D or E) from node B, the cognitive TAC agent first identifies the transitive sequence code of the present node. Based on the response from the sent questions and the identified transitive sequence code, the cognitive TAC agent decides the path to be selected to reach either node E or node D. While traversing to another cognitive node from the cognitive node, the cognitive TAC agent may also send the transitive sequence code associated with the cognitive node to another cognitive mode.

As the TAC session or the process of providing the technical support progresses, the transitive sequence code sequence coding so arrived at will be longer and longer as code chain that traces the TAC session questions and the answers picked up through the NLP engine. As previously discussed, each such transitive sequence code sequence code at a given node is linked to a set of questions from the knowledge base and the knowledge graph so that this sequence can be advanced till the service problem is solved.

In an embodiment, the path or the edge to be traversed from the cognitive node may be identified based on the received response to the one or more questions sent to the customer. For example, when a question, ‘Is RED LED is ON?’ is sent to the customer from the cognitive node, the technical support module 216 may map the response with edge name in the look-up table. For the above example, if the response from the customer is ‘YES’, then the technical support module finds an edge to be traversed for that particular response ‘YES’ from the look-up table associated with that cognitive node. Likewise, if the response from the customer is ‘NO’, then the technical support module finds an edge to be traversed for that particular response ‘NO’ from the look-up table associated with that cognitive node.

At 722, upon traversing to another cognitive node, the technical support module 216 may repeat the steps from 708 and 710. If the root cause of the technical problem is identified based on response received for one or more questions, associated with another cognitive node, sent to the customer, then the technical support module 216 may provide specific instructions at another cognitive node to resolve the technical problem. Further, the technical support may repeat the step 714 to obtain feedback from the customer.

If it is determined that the root cause of the technical problem is not identified at another cognitive node, then the steps 718 and 720 are repeated, and the process continues until the root cause is diagnosed and the technical problem is resolved. At 724, if the root cause of the technical problem is not identified after reaching a terminating node, i.e., end of the cognitive dependency graph, then the technical support module may escalate the technical problem to the technical expert for manual intervention.

Further, referring to step 706, if the cognitive node is not identified based on the extract intent or entity, then the technical support module 216 start the process from the root node and repeat the steps to provide the technical support for the product, as stated at 716.

In an embodiment, if the extracted entity is known, but state of parents of entity is not known, then the cognitive TAC agent may start traversing from the root node of the graph 234. For above printer example, if the problem statement contains “printer” or “printing” or “scanner” or “scanning”, but does not reveal the state (Red LED, Amber LED etc.), then the cognitive TAC agent 208 starts traversal process from the root node to provide the technical support.

In another embodiment, if the extracted entity is not known, then also the cognitive TAC agent 208 may start traversing from the root node for providing the technical support. For example, if the problem statement from the customer is “something is not working”, then this statement yields no entity. Therefore, the dependency graph 234 is traversed from “ABC Printer” root node and proceeds further in the graph 234 to provide the technical support.

Thus, the present subject matter provides the automated technical support for the product of the customer from the TAC 115 at the technical support end, and therefore minimizes the number of technical personnel required at the TAC. This may reduce the costs associated with hiring, training them sufficiently on a particular product or service.

The method of providing the technical support is explained herein with the cognitive dependency graph shown in the FIG. 6, for two technical problems received from the customer.

The above described process of the automated technical support is explained herein with two specific example technical problems. As will be appreciated, examples provided herein are for illustration purpose only and is not intended to be limiting any way.

By way of example, the TAC agent 208 and customer may engage in performing following steps for different technical problems.

Technical Problem 1 & the TAC Agent Progress:

Customer: My printer is not working (Actual problem—printer is not connected to a network).
Cognitive TAC Agent: Parses the statement ‘my printer is not working’, and extracts intent ‘working’ and entity ‘printer’.
Cognitive TAC Agent: Transitive Sequence code A; Selects a cognitive node ‘A’ based on the extracted entity ‘printer’ and sends a question associated with node ‘A’ to the customer.
Cognitive TAC Agent: Is Red LED ON? (Here Red LED is coded L)

### Customer: YES

Cognitive TAC Agent: Transitive sequence code is ALB
Cognitive TAC Agent: Is Amber LED ON? (Here Amber LED is coded X)

### Customer: NO

Cognitive TAC Agent: Transitive sequence code is ‘ALB!XE’

As can be seen from the dependency graph 234, from the cognitive node A, there are two paths ‘1’ and ‘0’ based on the response to the question, i.e., based on the state of the Red LED. If the Red LED is encoded as ‘L’ then the possibility is ‘L’ for ON and ‘!L’ for not ON. As the customer has provided response ‘YES’, the TAC agent 208 selects the edge L to reach a cognitive node ‘B’. The transitive sequence code: ‘ALB’.

When the support process reaches the cognitive node B, it indicates that the Power of the ‘ABC printer’ is ON. Next the TAC agent 208 sends a question at the cognitive node B to the customer.
Cognitive TAC Agent: Is Amber LED ON?
Customer: NO

As can be seen from the graph 234, from the node B, there are two possible paths based on the response to the question ‘Is Amber LED ON’. Amber LED is encoded X. Based on the customer response the TAC agent 208 selects the edge to be traversed from the cognitive node B. As the Amber LED state is determined to be OFF, the TAC agent 208 selects an edge ‘!X’ from the cognitive node B to traverse to cognitive node E. When the support process reaches the cognitive node B, it indicates that the Power of the ‘ABC printer’ is ON and the Network is not connected. The path traversed is: ‘ALB !XE’ .

When the list of nodes is very large and the coding for each unique node and edge needs more explicit codes, and the codes can contain more than one letter to have a parameter name. For example, RED LED and its presence in the transitive sequence code can be ‘!(RED LED)’ and ‘(RED LED)’ as the two possible edges with the usage of the (and) separators identifying transits in the sequence. Thus, the transitive sequence can be “(A) (RED LED)(D)(!Amber LED)(E)”. This scheme ensures that the NLP interface is simpler and readable with language parsers identifying intents and entities.

When the support process reaches the cognitive node B, it indicates that the Power of the ‘ABC printer’ is ON. Next the TAC agent sends a question at the cognitive node E to the customer. From the cognitive node E, there are two paths, as shown in the graph 234. The two possible paths are based on the type of network connection, i.e., Wi-Fi or Ethernet. Next, the TAC agent 208 sends a question associated with the cognitive node ‘E’ to the customer.
Cognitive TAC Agent: Is ABC printer using Wi-Fi or Ethernet?

Customer: Wi-Fi

As the ABC printer is using Wi-Fi, the TAC agent sends one or more questions related to the Wi-Fi connection and checks whether the Wi-Fi is properly connected or not.
Cognitive TAC Agent: Is your SSID correct?
Customer: No
Cognitive TAC Agent: Provides specific instructions to correct the SSID

As the corrective action has been taken by the TAC agent 208 to solve the technical problem, the TAC agent 208 army affirm if end-user problem is solved. If so, the technical support process will end. Else, the TAC agent 208 may traverse to other nodes to determine the root cause of the problem. Further, if the technical problem is not resolved after reaching the terminating node, the TAC agent 208 may escalate the problem to the technical expert for manual intervention.

### Technical Problem 2:

Customer: My printout quality is poor (Actual problem—toner level is low but not empty)
Cognitive TAC Agent: Parses the statement ‘My printout quality is poor’, and extracts entity ‘printout’. Identifies a relevant entity from the intent and entity database to select a start node for trouble shooting
Cognitive TAC Agent: Selects a cognitive node ‘A’ based on the extracted entity ‘printout’ and sends a question associated with node ‘A’ to the customer.

### Cognitive TAC Agent: Is Red LED ON?

### Customer: YES

As can be seen from graph 234, from the cognitive node A, there are two paths ‘1’ and ‘0’ based on the response to the question, i.e., based on the state of the Red LED. Based on the customer response ‘YES’, the TAC agent 208 selects the edge ‘L’ or ‘!L’ to reach a cognitive node ‘B’. The path traversed is: ‘ALB’.

When the support process reaches the cognitive node B, it indicates that the Power of the ‘ABC printer’ is ON. Next the TAC agent 208 sends a question connected to the sequence code ‘ALB’, which is encoded with the cognitive node B, to the customer.
Cognitive TAC Agent: Is Amber LED ON?
Customer: YES

As can be seen from the graph 234, from the node B, there are two possible paths based on the response to the question ‘Is Amber LED ON’. Based on the customer response, the TAC agent 208 selects the edge to be traversed from the cognitive node B. As the Amber LED state is determined to be YES, the TAC agent 208 selects an edge X from the cognitive node B to traverse to cognitive node D. When the support process reaches the cognitive node D, it indicates that the Power of the ‘ABC printer’ is ON and the Network is connected. The path traversed is: ALBXD.

As can be seen from the graph 234, from the cognitive node D, there are six different possible paths 0 to 6 to check for toner level, Paper feed mechanism and paper tray state. The TAC agent 208 starts sending questions associated with the sequence code ‘ALBXD’, which is encoded with the cognitive node D.

Cognitive TAC Agent: From the front panel, press button labeled as “Status” and check the “Toner Level” value shown in the display. What is the value shown?

### Customer: 8%

As the Toner Level is determined to be less than 10%, the TAC agent will take path ‘!T’, where ‘T’ encoding for the toner from the cognitive node D, and traverses to cognitive node G. The Path Traversed from the root node A: ‘ALBXD!TG’. When the process reaches to node F, it indicates that toner level is low, and therefore, the TAC agent sends specific instructions associated with the cognitive node G to solve the problem.
Cognitive TAC Agent: Toner level is low, and hence needs to be replaced.
Customer: OK

As the TAC agent 208 has provided specific instructions to solve the technical problem, the TAC agent 208 army affirm if end-user problem is solved. If so, the technical support process will end. Else, the TAC agent 208 may traverse to other nodes to determine the root cause of the problem. Further, if the technical problem is not resolved after reaching the terminating node, the TAC agent 208 may escalate the problem to the technical expert for manual intervention.

Thus, the present subject matter provides the automated technical support to the customer to troubleshoot the technical problem associated with the product, and therefore minimizes the number of technical personnel required at the TAC 115. This may reduce the costs associated with hiring, training them sufficiently on a particular product.

FIG. 8 is a flow chart of an illustrative method of updating a knowledge database based on a feedback from the customer, in accordance with an example embodiment of the present subject matter. As previously discussed, the feedback module 230 of the cognitive TAC agent 208 may obtain a feedback from the customer to update the knowledge database 232 and the intent and entity database such that further service requests from the customer can be successfully resolved.

In an embodiment, a customer at the remote end may request for a service request for a new feature of the product, and the cognitive TAC agent 208 may not have learned about the corresponding new feature of the product. Therefore, the extracted intents and entities, from the customer problem statement, pertaining to the new feature of the product may not be identified with any one of the cognitive node or in the intent and entity database. In such a case, the cognitive TAC agent 208 may not able to resolve the technical problem associated with the new feature of the product. Therefore, the knowledge database 232 and the intent and entity database of the TAC 115 have to be updated regularly such that further service requests pertaining to the new feature of the product can be successfully resolved.

At 805, the cognitive TAC agent 208 may check whether the feedback cache 238 is empty or not. If it is determined that the feedback cache is empty, i.e., the cognitive TAC agent 208 has not received the feedback from the customer, then the feedback process ends.

If it is determined that the feedback cache 238 is not empty, then at 815, the cognitive TAC agent 208 may prompt the technical expert or any other technical person or an administrator to parse a technical problem statement stored in the feedback cache 238 to extract intent and entity. At 815, a determination is made to check whether the extracted intent and entity are known or unknown. If it is determined that the extracted intent and entity are unknown, then the cognitive TAC agent 208 may start learning about the new feature of the product by repeating the method steps of the FIG. 3, as stated at 825. Further, based on the learning at step 825, the knowledge database 232 and the intent and entity database may be updated, as stated in steps 830 and 835. Referring back to step 815, if it is determined that the extracted intent and entity are known, then the cognitive TAC agent 208 update the correlation between the intent and entity such that the further service requests can be successfully resolved.

Thus, with the present subject matter, it is possible to identify the gaps in the knowledge database 232 and update the knowledge database 232. This provides an effective automated technical support to the end user. Further, the present subject matter is capable of providing the technical support to the hundreds of thousands of customers at same time. Because the same knowledge database 232 is used for all contact channels, it becomes possible to switch customers from telephone, email, or chat channels to web self-help whereby the customers are allowed to continue the diagnostic or trouble shoot session at their own place without the costly and lengthy interactions with the technical personnel.

Although implementations of present subject matter have been described in language specific to structural features and/or methods, it is to be understood that the present subject matter is not necessarily limited to the specific features or methods described. Rather, the specific features and methods are disclosed and explained in the context of a few example embodiments for providing the automated technical support to the customer.

We claim:

1. A method of automatically providing a technical support for a product at a remote end, using a cognitive Technical Assistance Centre (TAC) agent provided at a technical support end, the method being implemented by a computing device having a processing unit, the method comprising:
learning about the product having a plurality of components to construct a knowledge database having a look-up table of a set of questions and responses received from a technical expert to the set of questions, wherein the questions are related to the product and the responses include specific instructions to solve one or more technical problems related to the product;
constructing a knowledge graph from the learning process;
deriving a cognitive dependency graph based on the knowledge graph, wherein the cognitive dependency graph includes a plurality of cognitive nodes having a root node and a tree of nodes and edges connecting the cognitive nodes, and wherein deriving the cognitive dependency graph comprises:
encoding a transitive sequence code with each cognitive node, wherein the transitive sequence code represents a path from the root node to the corresponding cognitive node;
associating, a look up table having at least one of: one or more of the set of questions in the knowledge database with the transitive sequence code and possible responses for each question, an edge to be traversed based on the possible response, and one or more of the specific instructions for resolving a technical problem, with each cognitive node, wherein the one or more of the set of questions associated with the corresponding cognitive node depends on the transitive sequence code encoded with the corresponding cognitive node; and
providing the technical support for the product using the cognitive dependency graph, wherein providing the technical support comprises:
sending one or more of the set of questions associated with a cognitive node in the look up table, through a communication interface, to a customer at the remote end in response to a service request from the remote end, wherein the service request includes a statement of the technical problem with the product;
obtaining a response at the technical support end, through the communication interface, for each question that is sent from the remote end; and
processing the response to provide the technical support.

2. The method as claimed in claim 1, wherein the learning about the product further comprises:
generating the questions, by the cognitive TAC agent, related to each functional component, one or more sub-components of each functional component, one or more dependencies of each functional component and each sub-component, and operations associated with each functional component and each sub-component, wherein each question that is generated is based on a response from the technical expert for a previous question.

3. The method as claimed in claim 1, wherein the TAC agent employs a Natural Language Processing (NLP) technique for sending the one or more questions and obtaining the response to the questions.

4. The method as claimed in claim 1, wherein the processing the response for providing the technical support comprises:
based on the response, determining whether a root cause of the technical problem is identified, wherein the root cause of the problem is identified by mapping the obtained response with the possible response for the corresponding one or more questions stored in the look-up table;
if the root cause of the technical problem is identified, providing the one or more of the specific instructions associated with the cognitive node to the remote end to resolve the technical problem and ending the process of the technical support by traversing to the terminate node from the cognitive node, wherein the terminate node indicates an end of the dependency graph; and
if the root cause of the technical problem is not identified, identifying an edge to be traversed by mapping the obtained response with the possible responses and based on the transitive sequence code of the cognitive node to traverse to one of another cognitive node of the dependency graph through the identified edge.

5. The method as claimed in claim 4, wherein the method further comprises:
repeating the process after traversing to another cognitive mode through the identified edge; and
terminating the process of the technical support by escalating the technical problem to the technical expert if the root cause of the technical problem is not identified after reaching the terminating node.

6. The method as claimed in claim 1, wherein the method further comprises:
identifying the cognitive node from the plurality of cognitive nodes of the cognitive dependency graph based on at least one of an intent and an entity extracted from the technical problem statement.

7. The method as claimed in claim 1, wherein the cognitive dependency graph is uniquely associated with the product for which the technical support is to be provided.

8. The method as claimed in claim 1, wherein the functional components of the product include at least one of: one or more software components and one or more hardware components.

9. The method as claimed in claim 1, wherein the product is one of: an application software, a computer deployed device, a computer implemented support service.

10. A non-transitory computer readable medium having a set of computer readable instructions that, when executed, cause a processor to:
learn about the product having a plurality of components to construct a knowledge database having a look-up table of a set of questions and responses received from a technical expert to the set of questions, wherein the questions are related to the product and the responses include specific instructions to solve one or more technical problems related to the product;
construct a knowledge graph from the learning process;
derive a cognitive dependency graph based on the knowledge graph, wherein the cognitive dependency graph includes a plurality of cognitive nodes having a root node, a tree of nodes and edges connecting the cognitive nodes, and wherein the processor is configured to:
encode a transitive sequence code with each cognitive node, wherein the transitive sequence code represents a path from the root node to the corresponding cognitive node;
associate, a look up table having at least one of: one or more of the set of questions in the knowledge database with the transitive sequence code and possible responses for each question, an edge to be traversed based on the possible response, and one or more of the specific instructions for resolving a technical problem, with each cognitive node, wherein the one or more of the set of questions associated with the corresponding cognitive node depends on the transitive sequence code encoded with the corresponding cognitive node; and
provide the technical support for the product using the cognitive dependency graph, wherein the processor is configured to:
send one or more of the set of questions associated with a cognitive node in the look up table, through a communication interface, to a customer at the remote end in response to a service request from the remote end, wherein the service request includes a statement of the technical problem with the product;
obtain a response at the technical support end, through the communication interface, for each question that is sent from the remote end; and
process the response to provide the technical support.

11. The non-transitory computer readable medium as claimed in claim 10, wherein the computer readable instructions, when executed, further cause the processor to:
generate the questions, by the cognitive TAC agent, related to each functional component, one or more sub-components of each functional component, one or more dependencies of each functional component and each sub-component, and operations associated with each functional component and each sub-component, wherein each question that is generated is based on a response from the technical expert for a previous question.

12. The non-transitory computer readable medium as claimed in claim 10, wherein the computer readable instructions, when executed, further cause the processor to:
employ a Natural Language Processing (NLP) technique to send the one or more questions and obtain the response to the questions.

13. The non-transitory computer readable medium as claimed in claim 10, wherein the computer readable instructions, when executed, further cause the processor to:
based on the response, determine whether a root cause of the technical problem is identified, wherein the root cause of the problem is identified by mapping the obtained response with the possible response for the corresponding one or more questions stored in the look-up table;
if the root cause of the technical problem is identified, provide the one or more of the specific instructions associated with the cognitive node to the remote end to resolve the technical problem and ending the process of the technical support by traversing to the terminate node from the cognitive node, wherein the terminate node indicates an end of the dependency graph; and
if the root cause of the technical problem is not identified, identify an edge to be traversed by mapping the obtained response with the possible responses and based on the transitive sequence code of the cognitive node to traverse to one of another cognitive node of the dependency graph through the identified edge.

14. The non-transitory computer readable medium as claimed in claim 13, wherein the computer readable instructions, when executed, further cause the processor to:
repeat the process after traversing to another cognitive mode through the identified edge; and
terminate the process of the technical support by escalating the technical problem to the technical expert if the root cause of the technical problem is not identified after reaching the terminating node.

15. The non-transitory computer readable medium as claimed in claim 10, wherein the computer readable instructions, when executed, further cause the processor to:
identify the cognitive node from the plurality of cognitive nodes of the cognitive dependency graph based on at least one of an intent and an entity extracted from the technical problem statement.

16. The non-transitory computer readable medium as claimed in claim 10, wherein the computer readable instructions, when executed, further cause the processor to:
associate the cognitive dependency graph is uniquely with the product for which the technical support is to be provided.

17. The non-transitory computer readable medium as claimed in claim 10, wherein the functional components of the product include at least one of: one or more software components and one or more hardware components.

18. The non-transitory computer readable medium as claimed in claim 10, wherein the product is one of: an application software, a computer deployed device, a computer implemented support service.

19. A computer system for automating a process of technical support for a device at a remote end using a cognitive Technical Assistance Centre (TAC) agent provided at a technical support end and the device includes a plurality of functional components, the computer system comprising:
a learning module to learn about the product having a plurality of components to construct a knowledge database having a look-up table of a set of questions and responses received from a technical expert to the set of questions, wherein the questions are related to the product and the responses include specific instructions to solve one or more technical problems related to the product, wherein the learning module constructs a knowledge graph from the knowledge database;
a cognitive dependency graph generator module to derive a cognitive dependency graph based on the knowledge graph, wherein the cognitive dependency graph includes a plurality of cognitive nodes having a root node, a tree of nodes and edges connecting the cognitive nodes, and wherein the cognitive dependency graph generator module is configured to:
encode a transitive sequence code with each cognitive node, wherein the transitive sequence code represents a path from the root node to the corresponding cognitive node; and
associate, a look up table having at least one of: one or more of the set of questions in the knowledge database with the transitive sequence code and possible responses for each question, an edge to be traversed based on the possible response, and one or more of the specific instructions for resolving a technical problem, with each cognitive node, wherein the one or more of the set of questions associated with the corresponding cognitive node depends on the transitive sequence code encoded with the corresponding cognitive node; and
a technical support module to provide the technical support for the product using the cognitive dependency graph, wherein the technical support module is configured to:
send one or more of the set of questions associated with a cognitive node in the look up table, through a communication interface, to a customer at the remote end in response to a service request from the remote end, wherein the service request includes a statement of the technical problem with the product;
obtain a response at the technical support end, through the communication interface, for each question that is sent from the remote end; and
process the response to provide the technical support.

20. The computer system as claimed in claim 19, wherein the system further comprises:
a question generator and response parser (QGRP) module to generate the questions related to each functional component, one or more sub-components of each functional component, one or more dependencies of each functional component and each sub-component, and operations associated with each functional component and each sub-component, wherein each question that is generated is based on a response from the technical expert for a previous question.
